(19) United States
(12) Patent Application Publication
(10) Pub. No.: US 2023/0062924 A1
(43) Pub. Date: Mar. 2, 2023

(54) METHODS AND DEVICES FOR DETERMINING A LOCATION ASSOCIATED WITH A GEMSTONE

(71) Applicant: Opsydia Ltd, Oxford, Oxfordshire (GB)

(72) Inventors: Simon John Henley, London Greater London (GB); Jonathan Robert Pease, London Greater London (GB)

(73) Assignee: Opsydia Ltd, Oxford, Oxfordshire (GB)

(21) Appl. No.: 17/791,704

(22) PCT Filed: Dec. 21, 2020
(86) PCT No.: PCT/EP2020/087536

§ 371 Date: Jul. 8, 2022

(30) Foreign Application Priority Data
Jan. 8, 2020 (GB) 2000240.8

(51) Int. Cl. G06T 7/73

(52) U.S. Cl. CPC G06T 7/73; G06T 2207/20081; G06T 2207/30181

(57) ABSTRACT

The present disclosure relates to a computer-implemented method, devices and systems for determining a location associated with a gemstone. That method includes training a data model to detect a characteristic associated with a feature of interest pertaining to a gemstones surface. The training including the steps of providing a plurality of training images of gemstones, each training image associated with a label for a feature of interest pertaining to a given region of a gemstone type and an output indicating the specific gemstone type for the label. An input image of a gemstone for which a location is to be determined is then provided to the trained data model, wherein the data model detects at least one characteristic in the input image that corresponds to a feature of interest in the plurality of training images, determines that characteristic in the input image is associated with the label in the trained data model that corresponds to said feature of interest, identifies that the gemstone in the input image is of the specific gemstone type associated with said label, and finally provides an output representation of the respective feature of interest of the respective region for the identified specific gemstone type. Then, based on the output representation, a location on a corresponding region of the gemstone associated with the input image can be determined

### FIELD

The present disclosure relates to methods, devices and systems for determining a location associated with a gemstone, and relates particularly, but not exclusively, to techniques for training a data model to detect characteristics associated with at least one type of gemstone.

### BACKGROUND

Measuring the size and shape of a gemstone is a common procedure used in a range of industrial processing machines in the gemstone trade. For example, laser surface marking of code numbers onto stones requires the location of a specific facet of the gemstone in order to align the mark. See for example the GEMscribe laser marking systems and method, accessed from the following webpage: http://www.oqisystems.com/gemscribegem-diamond-laser-inscription.html.

In existing systems such as these, a laser is focused onto the surface of the stone (e.g. a diamond) and a small-scale pattern is marked onto the surface using a laser beam. In order to locate a suitable area on the stone for the marking, typically a user of the system has to manually specify the mark location by either placing the stone at the correct place/angle or by adjusting the location/orientation of the mark to coincide with the facet of the stone. See for instance, see publication EP0054840A2 in relation to existing methods. In some cases, there may also be some form of image processing software that assists in locating the stone. This processing software may use a live video or a large series of individual images from a camera observing the stone.

Similarly, grading and sizing gemstones also requires precise measurement of the stone's geometry. This may involve taking multiple images of the stone and calculating a 3D geometry of the stone by locating edges, vertices or facets, such as the Methods and systems of imaging cut stones discussed in U.S. Pat. No. 9,519,961B2. Other examples can be seen from the information accessed from the webpages https://sarine.com/4c-grading/ or https://sarine.com/products/diamension-axiom/. These are examples of imaging technologies to grade a diamond, with a reference to artificial intelligence to determine the colour and clarity of a diamond, as well as an automated method to determine the shape otherwise referred to as the cut, such as brilliant cut, rose cut, Ceylon cut, checkerboard cut etc.) of the diamond. Such systems and associated software use laser scanning or complex lighting configurations to attempt to map the surface of a diamond.

In publication CN110033486A entitled Transparent Crystal Growth Process Edge And Volume Real-Time Monitoring Method And System, a system is proposed, using an artificial neural network (ANN) to measure the growth of transparent crystals by manually measuring the edges from a set of different images at a range of different angles, and producing a training data set to allow a prediction of a three dimensional (3D) structure of the growing crystal for estimating the volume for growth monitoring purposes.

In other fields of technology unrelated to gemstone applications, the use of orientation detection using neural networks is also used widely. For example, autonomous driving vehicles guidance software and human pose estimation all use some form of object orientation detection by extracting information from the image after localisation or segmentation routines are applied to an image. See for instance US patent U.S. Ser. No. 10/262,218B2 entitled “Simultaneous object detection and rigid transform estimation using neural network” where the orientation of a traffic sign is estimated using a neural network.

For an application in laser marking or escribing of a gemstone, the use of software to locate a gemstone in 2D/3D space is complicated by the varied appearance of a gemstones under illumination. For example, there are many different sizes and cuts of stones, and these all scatter light in complex patterns due to the very nature/purpose of the cut. This poses a problem for many conventional image processing software routines such as edge detection, thresholding or Hough lines transforms. The Sarine DiaMention systems/software mentioned above use laser scanning or complex lighting configurations to map the surface of a diamond. This adds complexity and reduces the applicability of the process to more simple optical systems. For example, the Sarine DiaMention system is an external system used to map a stone before passing onto marking/cutting system. In another example, the Sarine DiaScribe software for laser marking uses a strong back light to produce a “shadow image” of the stone. The stone is then rotated around its centre to map the shape by using a vision routine (edge detection) to measure the edges of the shadow. The data from all the images then appears to be assembled into a 3D map of the stone.

Thus, a method and system which could deal with more varied lighting conditions and with fewer (or just one) image for laser marking applications is desirable, as this could make the process faster and more reliable.

To address the drawbacks of existing systems discussed above, the inventors of the present disclosure provide a novel and improved method and associated devices and/or systems for automatically determining a location associated with a surface, such as an edge or facet, of a gemstone. In particular, but in no way limiting, the techniques proposed in the present disclosure enable determination of a location on a gemstone that is suitable for marking or inscribing the gemstone.

### SUMMARY

The present disclosure relates to a computer-implemented method, devices and systems for determining a location associated with a gemstone. That method includes training a data model to detect a characteristic associated with a feature of interest pertaining to a gemstones surface. The training includes the steps of providing a plurality of training images of gemstones, each training image associated with a label for a feature of interest pertaining to a given region of a gemstone type and an output indicating the specific gemstone type for the label. The training image may also be an image containing multiple features. In this case, the training data also included a label and coordinates within the larger image defining the region or regions containing the features. An input image of a gemstone for which a location is to be determined is then provided to the trained data model, wherein the data model detects at least one characteristic region in the input image that corresponds to a feature of interest in the plurality of training images, determines that the characteristic in the input image is associated with the label in the trained data model that corresponds to said feature of interest, identifies that the gemstone in the input image is of the specific gemstone type associated with said label, and finally provides an output representation of the respective feature of interest of the respective region for the identified specific gemstone type. Then, based on the output representation, a location on a corresponding region of the gemstone associated with the input image can be determined.

The present disclosure also relates to a method, device and system for marking a gemstone using a laser marking system that includes one or more processors associated with a memory or data store, camera and a laser source or pointer. The method includes obtaining an image of a gemstone for which a location is to be determined, as captured by the camera, and providing this image as an input to a data model. The location suitable for marking the gemstone can be determined based on the method as implemented by the data model, discussed above. Then, either the gemstone or the laser pointer is moved or adjusted until a coincidence with an output representation from the data model is reached, so that the marking can be performed at the determined location on a surface of the gemstone.

### BRIEF DESCRIPTION OF THE FIGURES

FIG. 1 is a schematic diagram of an example of a laser marking system for gemstones for one application associated with the present disclosure.

FIG. 2 is a flowchart depicting an overview of locating a feature in a gemstone according to a first aspect of the present disclosure.

FIGS. 3a and 3b illustrate examples of annotated images of gemstone vertices, in accordance with the first aspect.

FIG. 4 illustrates one possible 2-dimensional geometric method for determining the centre of facet, according to the first aspect.

FIG. 5 is a schematic illustration of the process for training an artificial neural network according to the first aspect.

FIG. 6 illustrates a schematic overview of a possible artificial neural network (ANN) architecture based on Faster-RCNN (Faster-Region Convolutional Neural network), for the first aspect

FIG. 7 is a flow diagram showing a prediction process using an ANN to locate specific features in a gemstone, according to the first aspect.

FIG. 8 is a flow diagram showing a prediction process using an ANN to segment specific facets in a gemstone, according to a second aspect of the present disclosure.

FIG. 9 depicts a computing device for implementing one or more methods according to aspects and embodiments of the present disclosure.

### DETAILED DESCRIPTION

The present disclosure relates to a computer implemented method for determining a location associated with a gemstone.

The method includes the step of training a data model to detect a characteristic associated with a feature of interest pertaining to a gemstone surface. In some embodiments, the data model is implemented as an artificial neural network(ANN). In most cases, although not so limited, the ANN is a convolutional neural network (CNN). Examples of such a network could be, but are not limited to Region (R)CNN, Fast-RCNN, Faster-RCNN, YOLO, YOLOv3, and other derivatives including custom implementations designed with similar structures and written in a suitable computer programming framework, such as TensorFlow.

Training the data model includes providing a plurality of training images of gemstones. In some embodiments a large number, usually more than 1000 images are provided. In some embodiments, the plurality of training images can be obtained from a database of known gemstone types or obtained by crowdsourcing such images of gemstones or by generating synthetic or artificial images using image generation programs for a plurality of known gemstone types. Each training image pertains to a gemstone type among a plurality of types of gemstones. In some embodiments, the gemstone types relate to a cut, i.e. the shape, of a gemstone. Examples of gemstone types includes cuts such as Step, Brilliant, Princess, Ceylon, Rose, Cabochon, Barion, Checkerboard, Eight and Old Mine. In some cases, the shape such as round, heart etc. may also be used to specify the type, i.e. round brilliant-cut gemstone. In some embodiments, the plurality of images can be provided as a database or as a single data file in a suitable format or as individual images. In some embodiments the plurality of training images may be subjected to image processing operations before being provided to the data model, said image processing operations including rotating, resizing, shifting and/or modifying brightness or contrast of the image. This may be advantageous for ensuring that any differences in dimensions or orientations or other properties of a training image do not pose as a deterrent or introduce inaccuracies when being applied either to train the data model or when used make determinations or predictions or recognitions based on the training image.

Then, for a given training image among said plurality the following information is provided to train the data model. The given training image among the plurality may relate to each given image in the plurality, or may in some embodiments relate to one or some or all, i.e. each of the training images. The training images and the information may in some embodiments be provided in the form of a data file or data structure or a database that includes annotations or description associated with a given training image:
a training input including a label or an annotation for a feature of interest associated with a given region or an image of a given region of the gemstone type; and
a training output identifying a specific gemstone type that is associated with the feature of interest pertaining to the label.

The provision of above training input and output may in some embodiments be repeated for one, or some or all of the images in the plurality of training images. In most cases, each training image with have at least one training input and one training output.

In some embodiments related to the training input, the feature of interest can include a plurality of said features of interest having a common characteristic, i.e. feature of a same class or kind or type. Advantageously, a combination of said features of interest increases the accuracy of any determinations or predictions made based on said feature. For example, a gemstone of a given type can have a number of surfaces, each with characteristics or features that are specific or unique to said gemstone type. For instance, a brilliant cut gemstone type will have a region, i.e. a main surface or table facet, with features that will be different to features of interest of the same surface, i.e. a table facet, of a checkboard cut or princess-cut type of gemstone. In some embodiments, for a single training image a plurality of features of interest for a different surface or facet may be possible. So, for example, the table facet of a princess-cut gemstone type will have features that are different to a different surface of the same gemstone type.

In other embodiments, the feature of interest may be or includes a region of interest on a given facet or surface of a gemstone type.

In some embodiments related to the training input, the given region is associated with a facet of the gemstone type associated with the given training image being considered. In some embodiments this given region is a particular surface or facet of the gemstone type, such as the table facet or girdle facet or crown facet, although the disclosure is not so limited and can be applicable to any surface or subsurface or facet of the gemstone. The table facet is the large, horizontal facet on the top which acts as a window into the interior of a gemstone. The girdle facet is the widest part of the gemstone. The crown facets are also usually around the top and are referred as such for certain cuts. Other facets, such as the pavilion, which is the bottom of a faceted gem can also be considered. While the present disclosure will, for ease of reference, discuss the table facet hereinafter, this disclosure is not so limited.

In a first aspect of the present disclosure, the feature of interest for the training input is a vertex, or a plurality of vertices associated with a given facet for a given gemstone type.

So, for example the feature of interest may be one or more vertices of a table facet (or any other facet, but all vertices of the same facet are to be considered together as one kind or class of feature of interest. Other types of vertices will be considered a different feature of interest). Thus, the label or annotation in the training input will indicate that the feature of interest is a vertex of a table facet. Other vertices relating to a different facet, such as the girdle, of the same gemstone type may also possible. Thus, in this case another label for the same training image is included in the training input which will indicate that the feature of interest in this case is a vertex of a girdle facet. It is advantageous to train the data model based on different vertices of different facets of the gemstone to enable more accurate and error free detection of said vertices belonging to a particular facet by the data model.

In the first aspect, the training output includes an indication or result or annotation specifying the gemstone type of the given training image that corresponds to the label in the training input. So, in the above example assuming that the label for the feature of the interest, which is a vertex, indicated that it is a vertex of a table facet, let us consider that the gemstone type of the training image in question is a brilliant cut. In this case, the training output will indicate that the label (for the vertices) relates to a brilliant cut gemstone type. Thus, from both the training input and the training output for the training image, the data model can be trained to identify that such characteristics when encountered or detected relate to vertices of a table facet of a brilliant cut gemstone.

Advantageously, the data model can be trained in a similar manner for a plurality of different features of interest for the same and different types of gemstones. Thus, for the first aspect, the data model is trained to identify and classify vertices as belonging to a particular facet of a particular gemstone type, i.e. classify vertices as belonging to a table facet of a princess-cut gemstone.

In some embodiments, when a plurality of training images are provided, with a label identifying a feature of interest, i.e. a vertices that belong to a table facet, and with the training output indicating that such feature of interest relates or is classified as being that of a brilliant cut gemstone type; after a certain number of training images with said feature of interest for a given gemstone type, the data model will be able to automatically deduce and predict that such gemstone is a brilliant cut gemstone (without requiring this to be confirmed or described by the training output or any other label). In this case, in some embodiments, if the number of vertices are for instance eight, then the data model now trained to identify table vertices of a brilliant cut gemstone can be configured to generate a polygon outline or a boundary connecting the identified vertices for such specific gemstone type, i.e. the brilliant cut.

In a second aspect of the present disclosure, the feature of interest is a portion of a given facet among a plurality of facets of a given gemstone type. In some embodiments, this may be a segment or area associated with the given facet, such as a part or segment of the table facet of the gemstone type in the training image in question. In some embodiments, the portion includes the whole given facet, i.e. where the portion is the entire table facet for instance.

In the second aspect, the label or annotation provided in the training input for a given training image includes a segmented mask that indicates a portion in the given facet that corresponds to the feature of interest of the gemstone type in the given training image.

Thus, if the portion in the whole table facet, then the segmented mask will indicate the segment or portion of the mask that corresponds to the table facet for the training image. The label will also specify that the feature of interest, i.e. portion, relates to a table facet. In some embodiments, the segmented mask is a further image representing the given training image, where the portion indicated in the segmented mask has a first pixel intensity that is different to the pixel intensity of the rest of the segmented mask. So for example, if the feature of interest is a portion or the whole of the table facet, then according to the second aspect the label or annotation in the training input will include a segmented mask as a black and while image relating to the given training image, where the portion corresponding to the table facet alone is in black colour, i.e. of a lower pixel intensity, while the rest of the mask is in white, i.e. a high intensity. The label will also indicate that such portion in the segmented mark is the table facet.

As with the first aspect, the training output includes an indication or result or annotation specifying the gemstone type of the given training image that corresponds to the label with the segmented mask. So, in the above example assuming that the label for the feature of the interest, which is a portion or segment, indicates that the segmented mask has a high-intensity portion corresponding to the table facet, let us consider that the gemstone type of the training image in question is a brilliant cut. In this case, the training output will indicate that the label relates to a brilliant cut gemstone type. Thus, from both the training input and the training output for the training image, the data model can be trained to identify that portions or segments of an image with the same or similar characteristics as the segments or portions of interest, when encountered relate to a whole or part of a table facet of a brilliant cut gemstone.

Advantageously, the data model can be trained in a similar manner for a plurality of different features of interest, i.e. portions, for the same and different types of gemstones. Thus for the second aspect, the data model is trained to identify and classify segments of an image or portions as belonging to a particular facet of a particular gemstone type, i.e. classify the segments as belonging to a table facet of a princess-cut gemstone.

In some embodiments the training methods or data associated with first and second inputs can be combined. Thus, the training input may be based on a first feature of interest, i.e. one or more vertices for a given region or facet as with the first aspect, and a second feature of interest, i.e. a portion of the given facet of a specific gemstone type. The feature of interest may be provided at the same or at different times to the data model. For instance, in some embodiments, the second feature of interest may only be used after the data model has been trained based on the first feature of interest. Advantageously, having a data model trained based on a number of different kinds of features improves the ability of the data model to be able to easily and accurately detect and classify images having one or more or both types of features in a scalable, effective, less complex and accurate manner.

In a third aspect of the present disclosure, the feature of interest is an orientation parameter associated with a given facet for a given gemstone type. In some embodiments, the orientation parameter is a rotational angle associated with the given facet, or a distance from a predetermined point on the given facet. In the third aspect, the label in the training input includes a value for said orientation parameter. For the third aspect, rather than being trained to classify one or more input features, as with the first and second aspect; the data model in the third aspect is trained to identify or extract the orientation parameters, such as rotational angles (e.g between 0 to 360 degrees), or position in millimetres from a given point, of a gemstone image using a linear regression techniques, i.e. to extract and minimise the error until a suitable output is obtained.

After the data model has been trained, whether by the first, second or the third aspects and associated embodiments discussed above, the present disclosure then includes the step of providing an input image of a given gemstone to the trained data model. The given gemstone in this case is the gemstone for which a location is to be determined. In some embodiments, the location may be required for marking a facet of a gemstone. In some embodiments this input image is a recorded or live image of the given gemstone captured by a camera. In some embodiments, the camera may be associated with a laser marking device.

The trained data model then implements the following steps upon receipt of the input image:

(a) detecting at least one characteristic in the input image that corresponds to a feature of interest in the plurality of training images.

For the first aspect, where the feature of interest in a vertex or a plurality of vertices of a table facet of a gemstone type of a training image, in this step one or more characteristics that match with or are correspond to feature interest are detected as vertices of a table facet

In the second aspect where the feature of interest is a portion or segment of a facet, the step includes detecting a portion of the input image that corresponds to the portion having the first or different pixel intensity, i.e. in a different colour, in a segmented mask of a training image a gemstone type.

In the third aspect, this step includes identifying an orientation parameter associated with the input image having a low or minimal error or difference in value when compared to the value included in the label of the corresponding orientation parameter in a training input.

(b) determining that at least one characteristic in the input image is associated with a label in the training input that corresponds to said feature of interest.

Thus, for all three aspects, the label in the trained data model that corresponds or match up with the detected characteristic is determined as being the label or annotation for the detected characteristic.

(c) identifying that the given gemstone in the input image is of the specific gemstone type associated with said label.

Thus, for all three aspects, once the label is determined, the training output that pertains to the label is identified. As mentioned above, this reveals an overall classification result associated with the gemstone, which is specific type of gemstone, i.e. whether the input image is a princess cut or brilliant cut gemstone etc.

(d) providing an output including a representation of the respective feature of interest of the respective region pertaining to the identified specific gemstone type.

In this step, once the specific type has been identified, an illustrative representation of the feature of interest for the specific type is provided by the data model.

For the first aspect, the output representation includes a polygonal outline or a boundary or a bounding box that is based on or includes the vertices of the given facet of the input image that corresponds to the identified specific gemstone type, i.e. a boundary depicting the polygonal outline that connects all vertices of a table facet of a princess cut gemstone.

For the second aspect, the output representation is an indication of the segment or portion of a respective facet of the input image that has been detected as having the first intensity that is different to the rest of the image. Thus for example, the output representation will indicate a segment corresponding to the table facet of the specific gemstone type, i.e. princess cut table facet.

In embodiments where both the first as well as second aspects are combined during the training stage, a first output representation is obtained based on the characteristic in the input image of a gemstone that corresponds to a vertex of a first feature, i.e. table facet of a brilliant cut gemstone. As mentioned above, this is a polygonal outline of the vertices or a bounding box for the vertices. Then, using this first output representation one or more segmentation masks for the specific gemstone type can be generated. Then generated segmentation masks can then be provided as a feedback, to be included in a further or next or future training input to the data model, for use in detecting a second feature of interest, i.e. segments or portions. Advantageously, by using a feedback obtained from one feature of interest to further train the same data model for the specific gemstone type furthermore improves the accuracy, speed and reliability of the disclosed method for classifying characteristics of an input image for that specific gemstone type.

For the third aspect, the output representation is an indication of the value of the orientation parameter of the input image associated with the respective region, i.e. facet or surface, of the identified specific gemstone type that has the a low or minimal error or difference. Thus, unlike the first and second aspects, in the third aspect, the data model does not predict or provide bounding boxes or segment indications, but directly outputs a predicted value of the orientation parameter, for example, the rotation angle based on the extracted rotation angle learned during training.

Then, once the output representation from the data model has been obtained, whether using the first, second or the third aspect, the method of the present disclosure then includes the step of determining a location on a corresponding region of the gemstone associated with the input image.

Advantageously, since the output from the data model is based on a representation for the specific gemstone type of the input image, this output can be used to accurately determine a location on a surface the gemstone. So, if the type is a brilliant cut, that the centre of the table facet for this type of cut can be easily and accurately located using the output representation. This location may be used for marking the gemstone.

For example, for the first aspect, the polygonal outline can be overlapped or superimposed on the gemstone or image of the gemstone to identify the actual location of the table facet in the actual gemstone. In some embodiments relating to the first aspect, for two or more vertices of the table facet of the specific gemstone type, the intersection of the perpendicular bisectors of connecting lines of such vertices can also be used to further accurately depict the centre of the table facet for the specific gemstone type. Thus, accuracy of determining a location on the table facet is further increased. The output representation of the second aspect identifying the portion of interest in the segmented masks can also be used. In the third aspect, the location on a corresponding facet or region of the gemstone associated with the input image depicts the orientation of the gemstone.

The present disclosure also relates to a computing device or system including one or more processors and a memory for storing a computer program, the one or more processors configured to execute the computer program for implementing the method steps of any of the aspects and embodiments discussed above.

In some embodiments, the computing device or system also includes one or more processors for implementing a data model, said one or more processors configured to implement an artificial neural network (ANN) for implementing the steps carried out by the data model discussed above.

As will be evident from the above detailed discussion of a data model, the data model, i.e. an artificial neural network (specifically, but not limited to a convolutional neural network architecture), is trained to recognise and locate characteristic or features of interest on a gemstone surface. Advantageously, with varied training data, which may be in the form of labelled images, it is possible to produce an ANN that can identify these characteristics even in the presence of significant visual noise, contamination and variation of lighting. The ANN an also identify a specific type or class of cut of a gemstone by recognising specific features characteristic or unique to these cuts.

Advantageously, with the present disclosure it is then possible to identify and locate specific facets and vertices from a few (or even a single) images. The location of these facets can be used to determine the shape or cut of the gemstone, and a location related to these. Advantageously, the use of a trained ANN can reduce the complexity associated with imaging systems and increase the speed and reliability of the image processing routine in a specific matter as set out in the present method.

For example, publication CN110033486A mentioned above in the background section, proposes a process that appears to be limited to building a set of images from a range of angles and then predicting the volume of a crystal. In contrast, the present disclosure proposes improvements over this and other existing imaging classification technique because it allows classification of the feature of interest such as vertices to build a logical data model to compare with a known cut (or geometry or shape) of a gemstone. This advantageously allows a stronger set of geometric arguments and classifications to be applied to the known vertices based on prior knowledge of the approximate cut/shape.

Furthermore, the disclosed method is a significant improvement over conventional image processing routines used in other implementations of applications based on a location on a gemstone. Conventional methods require specific tailored solutions considering e.g. the image illumination and typically require extensive processing of the image in order to extract meaningful information. For example, in order to find the edge of a stone a black/white thresholding routine is typically required to be applied to a suitably lit image, followed by an edge fit routine. The darker or lighter regions can then be segmented as belonging to the stone or the background. Such methods only work provided the lighting does not vary significantly and the stone reflectivity/scatting is predictable and there are no impurities or blemishes at the edge of the stone. Whereas the method of the present disclosure described herein are an advancement in many ways (such as mentioned above) on these more structured and complex methods, as the steps implemented for training the data model according to the above aspects and embodiments are more robust to such variations.

An application of the method of the present disclosure for laser marking a gemstone according to the present disclosure will now be discussed. The method is implemented using a laser marking system that includes a laser source or pointer, camera and one or more processors for the managing the operation of the system.

The method includes the steps of obtaining by or from the camera, an image of a gemstone for which a location is to be determined.

The obtained image is then provided as an input image to a trained data model that is associated with the one or more processors of the laser marking system. In some embodiments, the data model is provided in the laser marking system, and in other embodiments the data model may be on a remote server or location or associated with a cloud platform, communicatively coupled via a communication network to the laser marking system.

The method then includes determining a location on a surface of the gemstone for marking. This step includes the method of the determining a location associated by the gemstone, as discussed above in relation to the first, second and third aspects of the present disclosure. In some embodiments, relating to the first aspect of the present disclosure, the output representation from the data model is a polygon outline or boundary associated with a plurality of vertices of a given facet of an identified specific gemstone type. In this case, the method includes the step of fitting or superimposing said polygon outline or boundary on a corresponding facet of the gemstone within which the laser marking is to be performed.

The method then includes moving the gemstone such that it coincides with an output representation from the data model, and/or or moving the laser source such that it coincides with the output representation. Laser marking is then performed using a laser beam from the laser source or pointer focussed at the location on the gemstone that corresponds to the determined location associated with the output representation. In some embodiments, relating to the first aspect of the present disclosure, the centre of the given facet based on the intersection of a plurality of vertices is determined, and the gemstone or the laser source or pointer is moved such that the laser beam is focussed at the determined centre.

In some embodiments, location on the gemstone for marking is also used to apply optical aberration corrections to the laser beam from the laser source, in order to focus the laser beam to a small volume within the gemstone to increase marking accuracy.

The present application also relates to a laser marking system including a base or mount for receiving a gemstone, a camera for obtaining an image of the gemstone; a laser source for providing a laser beam for marking a surface or subsurface associated with the gemstone, and one or more processors configured to implement the method set out above using the aspects and embodiments for determining a location associated with a gemstone of the present disclosure, to enable a more accurate, scalable, less complex, reliable, effective and efficient method for laser marking a gemstone.

Some specific components and embodiments of the disclosed method are now described by way of illustration with reference to the accompanying drawings, in which like reference numerals refer to like features.

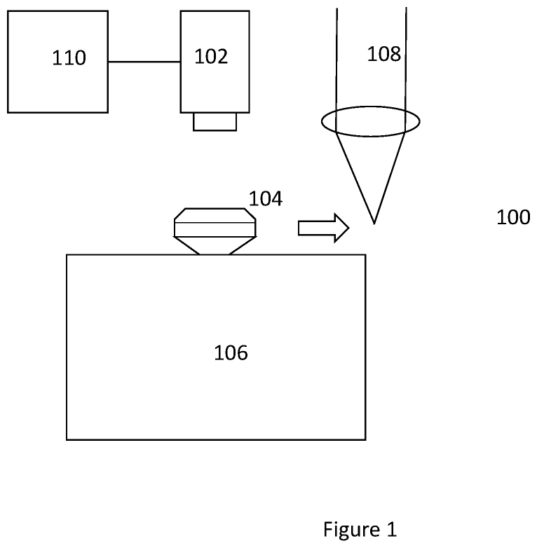

FIG. 1 is laser marking system for implementing a possible application of the method of the present disclosure discussed above, i.e. for laser marking on a surface or subsurface of a facet of a cut and polished gemstone (e.g. a diamond.) FIG. 1 shows a laser marking system 100. The system 100 includes a camera 102 to capture an image of a gemstone 104 that is provided on a mount 106. The mount 106 in some embodiments is capable of movement to adjust a position of the gemstone 104 it holds. A laser source or pointer 108 for use in the marking is provided. The laser source 108 is also capable of movement, in order to be aligned with the surface of the gemstone to be marked. A computing resource 110 associated with a memory or an image store is also depicted as part of the laser marking system.

For laser marking gemstone it is typically required that the location for the marking to take place on the gemstone is determined to a suitable accuracy, for example +/−20 microns. The high-level schematic diagram in FIG. 1 shows a laser marking system (for example, the Opsydia DM5000 diamond marking system) where the camera 102 is connected to the computing resource 110 to store images captured by the camera 102 in a digital format. Using images from this camera 102, the precise location, shape and orientation of a diamond must be determined in order to make the laser mark in the correct location on a facet of the diamond. While it will be possible for the user of the system to manually specify this location; this would be slower and more prone to human error when compare to an automated location and/or the alignment process for the marking.

Furthermore, where laser marking occurs below the surface of a facet of a gemstone, it may in some embodiments also be necessary to determine the location of the facet as well as orientation of the gemstone in order to apply optical aberration corrections to the laser beam in order to focus the laser beam to a small volume within the stone. In this case, determining the orientation of the facet with respect to a laser beam (not shown in FIG. 1) may sometimes be required and even crucial in some cases for determining the correct modifications to apply.

Therefore, for the application of laser marking as discussed in FIG. 1, as well as for other applications pertaining to the location of feature on a gemstone, the present disclosure proposed a technique for accurately determining a location associated with a gemstone using a data model such as an artificial neural network (ANN) architecture. This could be, but is not limited to, a convolutional neural network (CNN)) or a network with some at least some convolutional layers.

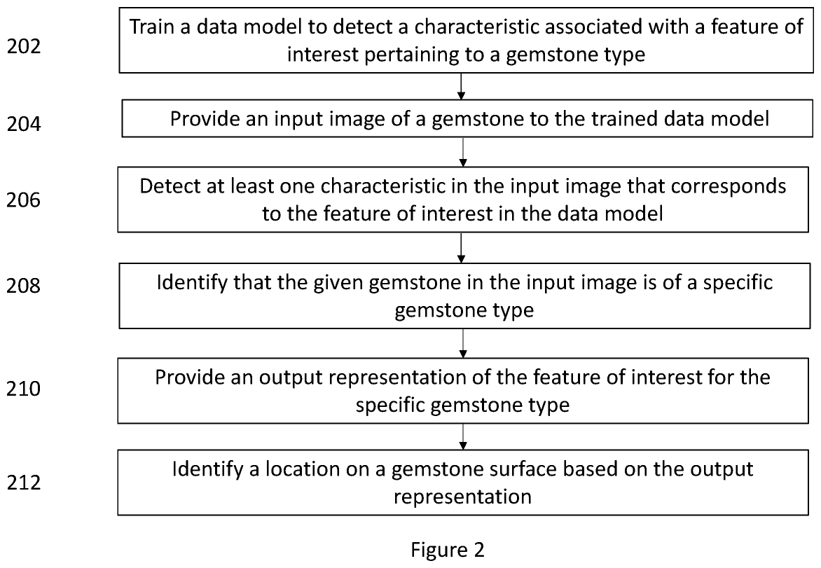

FIG. 2 is a flow chart depicting an overview of the method of the present disclosure for determining a location associated with a gemstone.

Step 202 depicts the training data model to detect a characteristic associated with a feature of interest pertaining to a gemstone.

As mentioned above, the data model is an ANN and, in some cases, a convolutional neural network (CNN).

ANNs (including CNNs) are computational models inspired by biological neural networks and are used to approximate functions that are generally unknown. ANNs can be hardware (neurons are represented by physical components) or software-based (computer models) and can use a variety of topologies and learning algorithms. ANNs can be configured to approximate and derive functions without a prior knowledge of a task that is to be performed and instead, they evolve their own set of relevant characteristics from learning material that they process. A convolutional neural network (CNN) employs the mathematical operation of convolution in in at least one of their layers and are widely used for image mapping and classification applications.

In some examples, ANNs usually have three layers that are interconnected. The first layer may consist of input neurons. These input neurons send data on to the second layer, referred to a hidden layer which implements a function and which in turn sends output neurons to the third layer. With respect to the number of neurons in the input layer, this may be based on training data or reference data that is provided to train the ANN.

The second or hidden layer in a neural network implements one or more functions. There may be a plurality of hidden layers in the ANN. For example, the function or functions may each compute a linear transformation of the previous layer or compute logical functions. For instance, considering that an input vector can be represented as x, the hidden layer functions as h and the output as y, then the ANN may be understood as implementing a function ƒ using the second or hidden layer that maps from x to h and another function g that maps from h to y. So the hidden layer's activation is f(x) and the output of the network is g(f(x))

In order to train the data model to detect a characteristic associated with a feature of interest pertaining to a gemstones surface, the following information is be provided to the data model:
a plurality of training images of gemstones, each training image pertaining to a gemstone type among a plurality of types of gemstones
for a given training image among said plurality,
   a training input including a label for a feature of interest associated with a given region of the gemstone type in the given training image; and
   training output identifying a specific gemstone type that is associated with the feature of interest pertaining to the label.

In one example associated with the first aspect, the features of interest are vertices with a label indicating that the features are associated with a table facet of a gemstone type. The training output in this example may be an indication that the gemstone type is a princess cut. Therefore, this indicates that the vertices in the given training images are classified as being vertices of table facet of a princess cut gemstone. Sufficient instances of such classes of vertices enables a bounding box to be established or generated based on the location of the vertices.

Thus in this step, the data model is trained to detect the vertices and also apply a classification to each of these vertices. For instance, “this is vertex recognised as one of the vertices from the table facet of a round brilliant cut gemstone” or “this is one of the vertices from the griddle of a trillion cut stone”. A plurality or collection of all such classifications provides the overall classification of the stone as a training output e.g. “this is a round brilliant cut gemstone”.

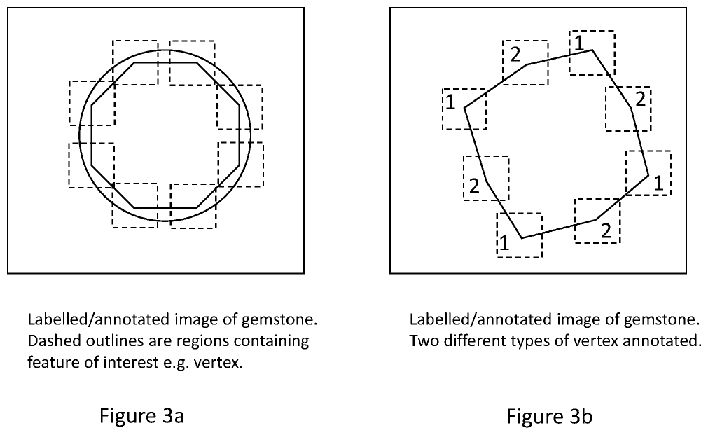

Thus, in the first aspect, the data model is trained to classify each vertex found in a training image into different classes or kinds or sets of vertices based on its location and the cut of the gemstone. An example of one of these sets could be “the vertices around the table facet of a round brilliant cut stone”. If the data model produced about eight of these similarly classified points, the data model is then trained to determine that that the gemstone is a round brilliant cut and the vertices are all mainly of the table facet. These eight points (or fewer) can then be used to build or generate a polygon outline defining the table facet for a round brilliant cut gemstone type, as seen in FIG. 3a.

Some gemstone types have 2 different sorts of vertices around their table facet, such as seen in FIG. 3b. For instance, a princess cut has four “sharp vertices 1” and four “wide vertices 2” as shown in FIG. 3b. In this case, during training the data model outputs region or feature it thinks are “wide vertices of the table facet of a princess cut stone” or “sharp vertices of the table facet of a princess cut stone. With enough training images of either subset (sharp or wide), a model of the table facet of the princess cut gemstone can be formed.

The training images, training input and training outputs has already been described in some more detail in the above discussion of the method of the present disclosure.

A large number, for example over 1000(s), of training mages of features of interest or each class of feature is required. In some embodiments, a computer data file containing the defined location of features of interest and associated labels for all the training images is constructed by human input (also known as annotation). For example, for the first aspect as discussed above where the features of interest are vertices of a given facet, FIG. 3 shows schematic examples of gemstones with specific type or types of vertices annotated with labels to define the kind or class of the vertices. FIG. 3a shows the vertices associated with an octagonal symmetrically cut gemstone, while 3b shows two classes of vertices for a princess cut gemstone.

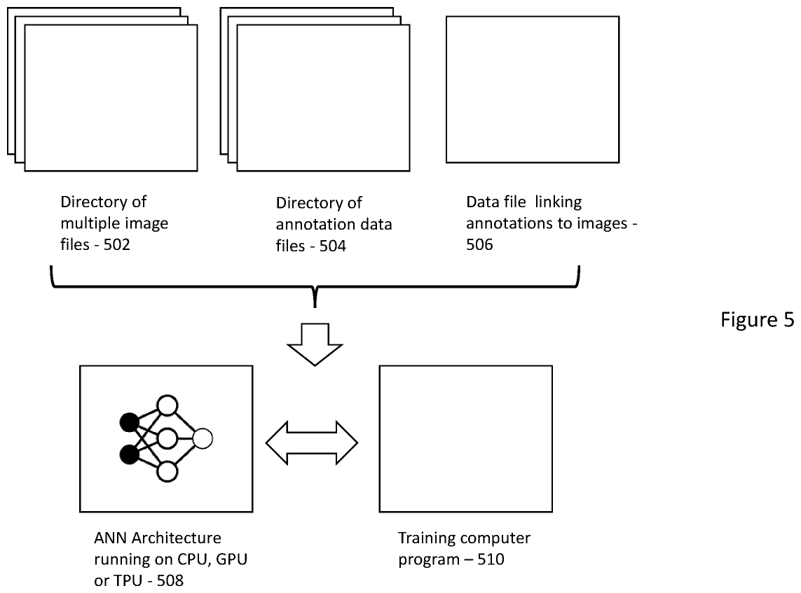

FIG. 5 shows the data structures used to train the ANN. In this example, a directory of multiple training image files 502, a directory of annotation data files or labels 504 and a data file linking the annotations to the images, 506, is shown, but the data structures are not limited to these, and other are also possible. In some examples, the ANN architecture 508 may be one that can define bounding boxes or polygon outlines or regions for the features of interest within a training image, and also assign a pretrained classification to those features using the annotations or labels in the training input. Examples of such a network could be, but are not limited to RCNN, Fast-RCNN, Faster-RCNN, YOLO, YOLOv3, and other derivatives including custom implementations designed with similar structures and written in a suitable programming framework 510. The execution of the ANN routines would be typically completed by running the ANN 508 on a suitable computing resource. The calculations could be performed on either the central processing unit (CPU) of the computer or a graphics processing unit (GPU) or a dedicated tensor processing unit (TPU) or a combination of any of the above. The location of the data files and any code/structure/weights for the ANN could be stored on the computing resource or accessed via the Internet, for example via a cloud storage platform.

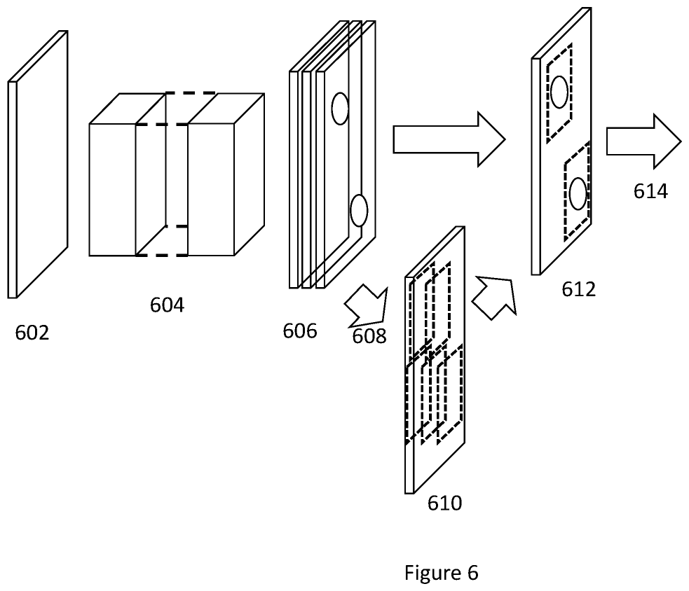

FIG. 6 shows an example schematic implementation using the Faster-RCNN architecture for the data model whereby a region proposal network (RPN) is part of the data model. In this implementation, an input of a plurality of training images is shown as 602. For the step of training in step 202 of FIG. 2, the training input as well as the training output discussed above is also provided. The ANN includes one or more Convolutional layers 604 that are capable of performing feature extraction from the input images 602. In some examples, feature maps 606 are also considered, before the training image is analysed in a Region Proposal Network 608 where processing associated with the labels and/or training output may take place. Region or feature proposals 610 may then made for training the data model. In some cases, a Region of interest pooling layer 612 may also be provided. The output obtained during training may include classes of the feature of interest as well as a bounding box associated with the type gemstone in the training image. Examples of the bounding boxes for different classes of vertices are seen in FIG. 3.

In step 204, an input image of a gemstone for which a location associated with its surface is to be detected is sent to the trained data model. In some embodiments, this input image may be a live or recorded static or dynamic, such as video, image of the gemstone. In some embodiments, the input image is provided from the camera 102 from the laser marking system 108 in FIG. 1, where a location for marking gemstone 108 is to be detected by the data model discussed herein.

Step 206 depicts a step detecting at least one characteristic in the input image obtained in step 204 that corresponds to the feature of interest in the data model.

Thus, considering the first aspect, when the data model has been trained based on vertices of given surface such as a table facet of a specific types of gemstone, if such characteristics that correspond to a kind or class of vertices, i.e. vertices of a table facet, are seen in the image, then it can be detected that the input image has such vertices. This step then further includes classifying the detected vertices by determining that the at least one characteristic detected in the input image is associated with a label in the training input that corresponds to said feature of interest. Thus, in this step, the trained data model has determined that the vertices detected correspond to a table facet of a gemstone type.

In step 208, the data model then identifies the given gemstone in the input image as being of a specific gemstone type. Considering the first embodiment as discussed above, if a sufficient number of characteristics that correspond to the feature of interest indicating that it is a vertex of a table facet, then the trained data model is able to determine that the vertices relates to a specific type of gemstone, i.e. a specific cut, based on the indication in the training output that corresponds to the label(s) assigned to the same feature of interest during training. Thus if the characteristics detected in the images are determined as belonging to a table facet of the gemstone type-round brilliant cut, then in this step it can be identified that the type of gemstone in the input image for which the location is to be predicted is a round brilliant cut gemstone.

In some embodiments, the steps 206 and 208 can be combined or implemented as a single step, where a trained data model will be able to straightaway identify that the vertices of a given input image relates to a table facet of a specific type.

The data model, as mentioned above is an ANN or CNN that is trained (in step 202) by deep learning techniques to locate and classify specific features in a recorded or live video image of a gemstone. These features are typically vertices of the facets of the gemstone, as with the first aspect but could be specific whole facets in another implementation, as discussed in relation to the second aspect where segmented masks are used. ANNs of a suitable structure, such as discussed in relation to FIGS. 5 and 6, are capable, after suitable training, of classifying regions of their input image as belonging to a defined class. It is thus possible for the ANN to predict the cut of a gemstone based on the amalgam of the detected or extracted features of interest. As an example, the “round brilliant” diamond cut has a characteristic set of vertices, which are different from other diamond cuts such as checkerboard or princess.

Advantageously, the aspects and embodiments of the present disclosure is an advancement on the existing systems discussed in the background section for determination of shape of a gemstone using ANN methods, as the present disclosure involves a classification steps to determine and categorise the detected characteristics based on one or more individual features of interests of the image that are each classified during training. The collection of classifications of the such individual features of interest allows classification or identification of the specific cut of the gemstone and hence an improved set of geometric/symmetry arguments can be applied to determine the geometry.

In some embodiments, as part of the classification steps for the input image in steps 206 and 208, conventional image processing routines as discussed in the background section can also be used to extract extra information from the input image or regions of the input image identified as containing features of interest. For example, the Hough lines transformation could be applied to the pixels in the region previously identified as containing a vertex to extract linear features. This additional processing could be used to more accurately identify the location of the vertex once an image region of interest (without other visual clutter) has be obtained. This has also been discussed above in relation to the embodiments where the first as well as the second aspects can be combined, such that once a boundary associated with the vertices of the first aspect has been obtained, this can then be used to generate the segmented masks to be used as a training input to the data model.

Step 210 depicts the step of providing an output representation of the feature of interest for the specific gemstone type that has been identified in step 208. As mentioned above, once a certain number, for example 8, vertices of a table facet of a brilliant cut gemstone has been detected and classified as being of said specific gemstone type, a bounding box or outline for the table facet of the specific gemstone type can be generated. Thus, the output of this step for the first aspect is a polygonal outline for the table facet of the specific gemstone. For the second aspect, this representation may be an indication of the portion of the input image of the gemstone that corresponds to the region of interest representing the table facet of the gemstone and indicated by a different pixel intensity or colour.

In step 212, based on the output representation in step 210, a location on a corresponding region of the gemstone associated with the input image can then be determined. In embodiments relating to the first aspect, this may include the step of superimposing or aligning the polygon outline based on the detected vertices in associated with the input image of the gemstone, or the gemstone itself. For the laser marking system in FIG. 1, the gemstone 104 or the laser source 108 can be moved or rotated so that the table facet for instance coincides with the polygonal outline.

In some embodiments, for the application of laser marking once the cut of the stone has been classified, it is possible to use the location of a subset or subsets of the features of interest within the image to calculate a precise location and orientation of the gemstone based on simple geometric considerations to pinpoint where the mark is to be made.

An example of this application is to automatically fit a polygon outline of a facet from the ANN (such as the table facet of a gemstone) with the corresponding table facet within which the laser marked is to be performed.

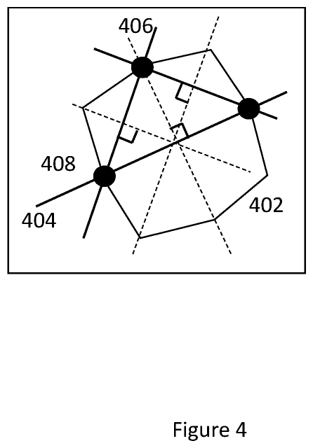

FIG. 4 shows another example of using a set of detected vertices of the same type to calculate the centre of a facet. This is by constructing a set of lines between these vertices and calculating the perpendicular bisectors of these lines. The facet outline 402 as provided for the output representation from step 210 is shown for vertices 408 that are detected to be wider vertices of a table facet of a princess-cut gemstone, for example. The connection between the vertices 408 are shown as solid connectors 404. The perpendicular bisectors of connectors 404 are then shown as dashed lines 406. In this example, the intersection of these perpendicular bisectors 406 is the centre of the table facet of the princess cut gemstone in this case. Similar sets of geometric rules can be built to analyse other facet geometries. In some embodiments, with a complete or nearly complete set of vertices, for a given facet, deformations of the gemstone from perfect symmetry can be calculated.

As mentioned above, the feature of interest considered for the training as well as the prediction or classification stage can be vertices of a facet of a gemstone in the first aspect, a portion of a facet in the second aspect or an orientation parameter in the third aspect. Although the steps of FIG. 2 have been explained in relation to the first aspect, the present disclosure is understood to not be so limited.

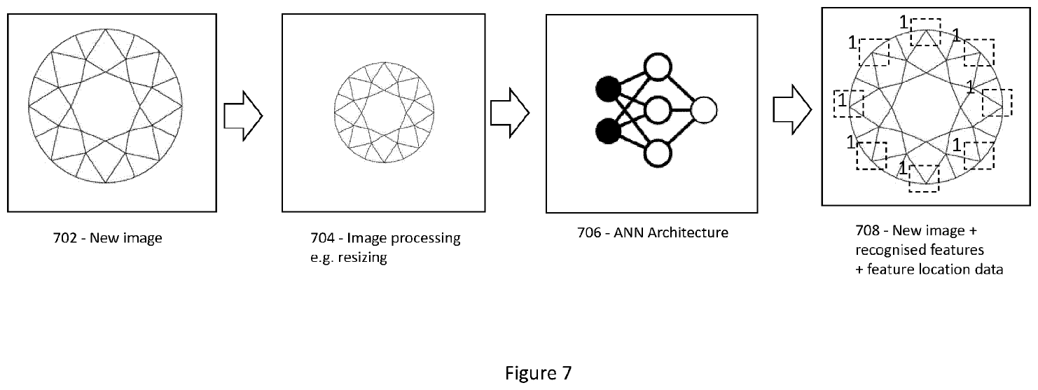

In relation to the first aspect, FIG. 7 shows the schematic processes flow for using an ANN trained by the techniques discussed above in relation to FIG. 2 for predicting the location of specific features on a gemstone. A new image, or an input image 702 provided from a camera (for instance the camera 106 in FIG. 1) is obtained. This image is either a live or a recorded image. In some embodiments, the new image 702 may be subject to image processing such as resizing, re-orientation, brightening etc. to provide a processed image 704 before it is provided as an input image to a trained ANN 706, which is trained using the above discussed techniques for the first aspect. The output 708 of the ANN 706 is then shown, where the vertices of the gemstone in the input image have been identified as vertices the table facet 1 of the specific gemstone type in the output representation 708. The output representation in this case includes the identification or location of the features of interest (dashed blocks), that have been recognised as being table facet vertices 1 for the image 702. This has been recognised by the ANN, as such as it matches the characteristics of the table vertices for a round brilliant cut gemstone as seen in the training input and associated labels and annotations in FIG. 3a. Thus, the gemstone in FIG. 7 can be deduced to be a round brilliant cut gemstone.

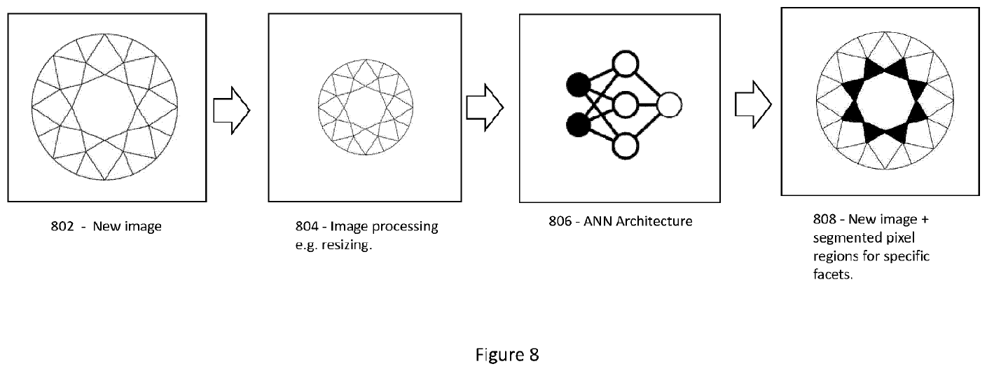

FIG. 8, like FIG. 7 also shows the processes flow for using an ANN trained, but in relation to the techniques discussed for the second aspect for predicting the location of specific facets on a gemstone. In this case, the feature of interest is a portion of the facet, which may also be the whole facet.

Steps 802, 804 and 806 correspond to the steps 702, 704 and 706, respectively; except that the ANN 806 in this case has been trained to identify segments or portions of the facet that are the feature of interest, which are identified as or by having a different pixel intensity to the rest of the image. In this case, the ANN 806 is considered to be trained to detect segments or portions of a table facet of a round brilliant cut gemstone. The output 808 of the ANN 806 is then a representation that includes the identification or location of the features of interest (segmented image with high-intensity pixels), that have been recognised as being segments of a table facet of a round brilliant cut gemstone for the image 802.

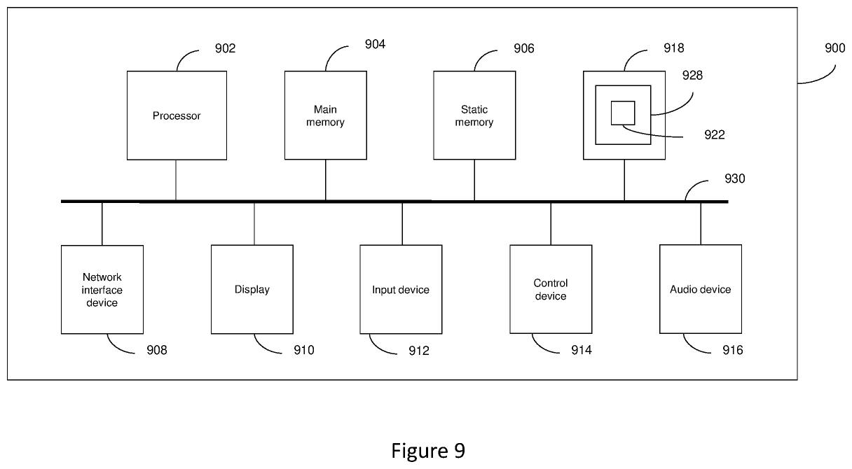

FIG. 9 illustrates a block diagram of one example implementation of a computing device 900 that can be used for implementing the steps indicated in FIG. 8 and explained throughout the detailed description. The computing device is associated with executable instructions for causing the computing device to perform any one or more of the methodologies discussed herein. The computing device 900 may operate in the capacity of the data model or one or more computing resources for implementing the data model for carrying out the methods of the present disclosure. In alternative implementations, the computing device 900 may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 900 includes a processing device 902, a main memory 904 (e.g., read-only memory (ROM), flash memory, dynamic random-access memory (DRAM) such as synchronous DRAM (SDRAM) or Rambus DRAM (RDRAM), etc.), a static memory 906 (e.g., flash memory, static random-access memory (SRAM), etc.), and a secondary memory (e.g., a data storage device 918), which communicate with each other via a bus 930.

Processing device 902 represents one or more general-purpose processors such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to execute the processing logic (instructions 922) for performing the operations and steps discussed herein.

The computing device 900 may further include a network interface device 908. The computing device 900 also may include a video display unit 910 (e.g., a liquid crystal display (LCD) or a cathode ray tube (CRT)), an alphanumeric input device 912 (e.g., a keyboard or touchscreen), a cursor control device 914 (e.g., a mouse or touchscreen), and an audio device 916 (e.g., a speaker).

The data storage device 918 may include one or more machine-readable storage media (or more specifically one or more non-transitory computer-readable storage media) 928 on which is stored one or more sets of instructions 922 embodying any one or more of the methodologies or functions described herein. The instructions 922 may also reside, completely or at least partially, within the main memory 904 and/or within the processing device 902 during execution thereof by the computer system 900, the main memory 904 and the processing device 902 also constituting computer-readable storage media. The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “providing”, “calculating”, “computing,” “identifying”, “detecting”, “establishing”, “training”, “determining”, “storing”, “generating”, “checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method for determining a location associated with a gemstone, the method including the steps of:
training a data model to detect a characteristic associated with a feature of interest pertaining to a gemstones surface, the training including the steps of:
providing a plurality of training images of gemstones, each training image pertaining to a gemstone type among a plurality of types of gemstones;
for a given training image among said plurality,
providing a training input including a label for a feature of interest associated with a given region of the gemstone type in the given training image; and
providing a training output identifying a specific gemstone type that is associated with the feature of interest pertaining to the label;
providing an input image of a given gemstone to the trained data model;
the method further comprises, implementing by the trained data model the steps of:
detecting at least one characteristic in the input image that corresponds to a feature of interest in the plurality of training images;
determining that the at least one characteristic in the input image is associated with a label in the training input that corresponds to said feature of interest;
identifying that the given gemstone in the input image is of the specific gemstone type associated with said label; and
providing an output including a representation of the respective feature of interest of the respective region pertaining to the identified specific gemstone type; and wherein,
based on the output representation, the method includes the step of determining a location on a corresponding region of the gemstone associated with the input image.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. The method as claimed in claim 1 wherein the feature of interest is a vertex, or a plurality of vertices associated with a given facet for a given gemstone type.

14. The method as claimed in claim 13 wherein the output representation includes a polygonal outline or a boundary that is based on the vertices of the given facet of the input image that corresponds to the identified specific gemstone type.

15. The method as claimed in claim 13 further comprising, for two or more characteristics of the input image that correspond to vertices of the given facet of the specific gemstone type, connecting said vertices and obtaining perpendicular bisectors of such connections; wherein the intersection of the perpendicular bisectors depicts the centre of the given facet for the specific gemstone type.

16. The method as claimed in claim 1 wherein the feature of interest is a portion of a given facet among a plurality of facets of a given gemstone type.

17. The method as claimed in claim 16 wherein the portion includes the whole given facet.

18. The method as claimed in claim 16 wherein the step of providing a label for a given training image includes providing a segmented mask for the given training image, the segmented mask indicating the portion in the given facet corresponding to the feature of interest of the gemstone type in the given training image.

19. The method as claimed in claim 18 wherein the segmented mask is a further image representing the given training image in which the portion indicated in the segmented mask has a first pixel intensity that is different to the pixel intensity of the rest of the segmented mask.

20. The method as claimed in claim 19 wherein the step of detecting at least one characteristic corresponding to a feature of interest includes detecting a portion of the input image that corresponds to the portion having the first pixel intensity in a segmented mask of a given training image that is of a given gemstone type.

21. The method as claimed in claim 20 wherein the output representation is an indication of the portion of the input image having the first intensity, the portion being in the facet corresponding to the respective given facet of the identified specific gemstone type.

22. The method as claimed in claim 16 including the method as claimed in claim 13, wherein in the step of providing the training input, the feature interest includes a first feature having one or more vertices for a given region, and a second feature having a portion of the given region, the given region being a facet of a specific gemstone type;
wherein for a first characteristic in the input image of a gemstone that corresponds to a vertex of the first feature, obtaining a first output representation; and
wherein, based on the first output representation, the method includes generating one or more segmentation masks for the specific gemstone type, the one or more segmentation masks being provided as a feedback to be included in the training input to the data model for the second feature.

23. The method as claimed in claim 1 wherein the feature of interest is an orientation parameter associated with a given facet for a given gemstone type, and wherein the label includes a value for said orientation parameter.

24. The method as claimed in claim 23 wherein the orientation parameter is a rotational angle associated with the given facet, or a distance from a predetermined point on the given facet.

25. The method as claimed in claim 23 wherein the step of detecting at least one characteristic in the input image that corresponds to a feature of interest includes identifying an orientation parameter associated with the input image having a low or minimal error or difference in value when compared to the value included in the label of the corresponding orientation parameter in the training input.

26. The method as claimed in claim 25 wherein the output representation is an indication of the value of the orientation parameter of the input image associated with the respective region of the identified specific gemstone type having the low or minimal error or difference, and wherein the determined location on a corresponding region of the gemstone associated with the input image depicts the orientation of the gemstone.

27. A computing device or system including one or more processors and a memory for storing a computer program, the one or more processors configured to execute the computer program for implementing the method steps of claim 1.

28. The computing device or system of claim 27 including one or more processors for implementing a data model, said one or more processors configured to implement an artificial neural network.

29. A method for marking a gemstone, the method implemented by one or more processors associated with a laser marking system, the laser marking system including a camera and a laser source or pointer, the method comprising the steps of:
obtaining by or from a camera, an image of a gemstone for which a location is to be determined;
providing the obtained image as an input image to a trained data model;
determining a location for marking by the method as claimed in claim 1;
moving the gemstone such that it coincides with an output representation from the data model, and/or or moving the laser source such that it coincides with the output representation;
performing laser marking using a laser beam from the laser source or pointer focussed at the location on the gemstone that corresponds to the determined location associated with the output representation.

30. The method as claimed in claim 29 wherein the output representation from the data model is a polygon outline or boundary associated with a plurality of vertices of a given facet of an identified specific gemstone type, and wherein the method includes fitting or superimposing said polygon outline or boundary on the corresponding facet of the gemstone within which the laser marking is to be performed.

31. The method as claimed in claim 30 further comprising determining the centre of the given facet based on the intersection of a plurality of vertices and moving the gemstone or the laser source or pointer such that the laser beam is focussed at the determined centre.

32. The method as claimed in claim 29 wherein the determined location on the gemstone for marking is used to apply optical aberration corrections to the laser beam in order to focus the laser beam to a small volume within the gemstone.

33. A laser marking system including:
a base or mount for received a gemstone;
a camera for obtaining an image of the gemstone;
a laser source for providing a laser beam for marking a surface or subsurface associated with the gemstone;
one or more processors configured to implement the method as claimed claim 29.
